(19) United States
(12) Patent Application Publication
(10) Pub. No.: US 2024/0330882 A1
(43) Pub. Date: Oct. 3, 2024

(54) SYSTEMS, METHODS, AND COMPUTER-READABLE MEDIA FOR DIGITAL PLACES

(71) Applicant: Brenden Michael Dearie, Phoenix, AZ (US)

(72) Inventor: Brenden Michael Dearie, Phoenix, AZ (US)

(21) Appl. No.: 18/191,799

(22) Filed: Mar. 28, 2023

(51) Int. Cl. G06Q 20/12; G06Q 20/38

(52) U.S. Cl. CPC G06Q 20/123; G06Q 20/3821; G06Q 2220/00

(57) ABSTRACT

This disclosure is directed to digital places, including related methods, systems, computer-readable media, and computer program products. Some embodiments may include circuitry configured for or a method comprising hosting a digital place to be displayed via a display of a user interface and integrating external service(s) into the digital place. The digital place may be authenticated by a non-fungible token (NFT) stored on a distributed ledger network. The external service(s) may provide visual and/or audio content to be presented via the user interface. The digital place may be provided by a first application provider, and the external service(s) may be provided by an external application provider(s). Non-transitory computer-readable storage may store parameter value(s) defining aspect(s) of the digital place. Visually perceptible trait(s) of the digital place may be based on the stored parameter value(s). The visually perceptible trait(s) may be displayed via the display of the user interface.

### FIELD OF THE INVENTION

This disclosure generally relates to digital places. More specifically, this disclosure generally relates to methods, systems, computer-readable media, and computer program products relating to digital places. The digital places may be displayed via a display of a user interface. The digital places may be authenticated by non-fungible tokens (NFTs) stored on a distributed ledger network.

### BACKGROUND

There are many digital environments, such as video games and digital art galleries, online or standalone. Each digital environment can be like its own digital world, and some digital environments may allow a user to own or have some personal land or space in that respective digital world. However, these digital worlds are fragmented in that they cannot connect to each other. Some users desire to seamlessly traverse from one digital environment into another digital environment while maintaining their same digital identity in both. Thus, there is a need for some technology that achieves or approaches such seamless transition between digital environments.

There is a concept of a common digital universe that may unify different digital worlds, which some may call a “metaverse.” Due to current technological limitations, lack of a standard for interoperability or even communication between diverse digital domains, etc., however, many believe a real-life implementation of a fully functional metaverse is technologically far away. In the meantime, there may be no technological solution that provides a digital bridge that can bridge two different digital environments, such as two different video game worlds. Thus, there is a need for technology that achieves or approaches such bridging between digital environments.

Online maps can provide useful services, such as directions between two geographical locations and navigation when combined with real-time GPS positioning data. However, some users may desire more detailed spatial information, such as a more specific location of a particular store in a large shopping mall located as a single street address. Also, online maps and GPS coordinates are limited to identifying a location or direction in two dimensions (e.g., x and y coordinates), such as the cardinal directions of north, south, east, and west. Some locations, however, may include destinations at multiple elevations (z-coordinates), such as multi-floor office buildings. GPS positioning data may include reliable x and y coordinate data, but less reliable or erroneous z-coordinate data. Thus, there is a need for some technology that obtains more detailed spatial information, such as a more specific location than a single street address and/or z-coordinate data at geographical locations.

Augmented reality (AR) technology intends to bridge the real world and the digital world. AR implementations are often limited to providing a solitary, dedicated AR experience only to a single user's game device at a time. For example, a first user's device may provide a first solitary dedicated AR experience, while a second user's device may provide a second solitary, dedicated AR experience different and independent from the first user's AR experience. Some users may desire to collectively participate in a common and persistent AR experience, each from a different perspective/device. Thus, there is a need for technology that achieves or approaches a mutually shared AR experience.

Distributed ledger technology, such as blockchain, can provide a variety of features including scarcity of digital assets, such as digital assets authenticated—and typically made scarce—by non-fungible tokens (NFTs). NFTs may commonly be linked to digital art images or short digital video clips, and users may manage their ownership of such NFT-authenticated images or videos through digital wallets, e.g., blockchain “wallets”. Digital wallets, however, are limited to a mere listing of a single owner's digital assets. Some users may desire to create a shared experience where multiple users can view or experience one user's collection of NFT-authenticated digital assets. For ease of reference in this disclosure, an NFT-authenticated digital asset may be referenced as an “NFT asset,” e.g., an “NFT image”, “NFT video”, “NFT artwork”, “NFT video game equipment”. Thus, there is a need for some technology that achieves or approaches such a shared experience of authenticated digital assets.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

This disclosure is directed to digital places, including systems, methods, and computer-readable media for digital places. Some system embodiments may include a system comprising: circuitry configured for: hosting a first digital place to be displayed via a display of a user interface, wherein: the first digital place is authenticated by a first non-fungible token (NFT), and the first NFT is stored on a distributed ledger network; integrating one or more external services into the first digital place, the one or more external services providing at least one of visual content and audio content to be presented in correspondence with the first digital place via the user interface, wherein: the first digital place is provided by a first application provider, the one or more external services are provided by one or more first external application providers, and the first application provider is different from the one or more first external application providers; and non-transitory computer-readable storage for storing one or more parameter values defining one or more aspects of the first digital place, wherein: one or more visually perceptible traits of the first digital place are based on the stored one or more parameter values, and the one or visually perceptible traits of the first digital place are to be displayed via the display of the user interface.

Some computer-readable medium embodiments may include a non-transitory computer-readable medium storing instructions, such that when the instructions are executed by one or more processors, the one or more processors are configured to perform a method comprising: hosting a first digital place to be displayed via a display of a user interface, wherein: the first digital place is authenticated by a first non-fungible token (NFT), and the first NFT is stored on a distributed ledger network; integrating one or more external services into the first digital place, the one or more external services providing at least one of visual content and audio content to be presented in correspondence with the first digital place via the user interface, wherein: the first digital place is provided by a first application provider, the one or more external services are provided by one or more first external application providers, and the first application provider is different from the one or more first external application providers; and wherein one or more parameter values defining one or more aspects of the first digital place are stored by a non-transitory computer-readable storage, wherein: one or more visually perceptible traits of the first digital place are based on the stored one or more parameter values, and the one or visually perceptible traits of the first digital place are to be displayed via the display of the user interface.

In some embodiments, the first digital place comprises a first digital space, the first digital place is to be displayed via the display of the user interface by the first digital space being displayed via the display of the user interface, the one or more external services are integrated into the first digital space, the stored one or more parameter values defining one or more aspects of the first digital place define one or more aspects of the first digital space, the one or more visually perceptible traits of the first digital place are one or more visually perceptible traits of the first digital space, and the one or visually perceptible traits of the first digital place are to be displayed via the display of the user interface by the one or more visually perceptible traits of the first digital space being displayed via the display of the user interface.

In some embodiments, the circuitry is further configured for or the method further comprises: hosting a second digital place to be displayed via the display of the user interface, wherein: the second digital place is authenticated by a second NFT, and the second NFT is stored on the distributed ledger network; and connecting the first digital place to the second digital place, wherein traversing between the first digital place and the connected second digital place occurs via a portal visually presented in the first digital place, the visually presented portal to be displayed via the display of the user interface.

In some embodiments, the circuitry is further configured for or the method further comprises: connecting the first digital place to a first digital world, wherein: the first digital place is provided by the first application provider, the first digital world is provided by a second external application provider, the first application provider is different from the second external application provider, and traversing from the first digital place to the first digital world occurs via a portal visually presented in the first digital place, the visually presented portal to be displayed via the display of the user interface.

In some embodiments, the circuitry is further configured for or the method further comprises: hosting a map program that maintains a map at least partially corresponding to geographical space; receiving a user input from a first user interface to anchor the first digital place to a geospatial location on the map, the geospatial location associated with the first user interface; and updating the map, based on the user input from the first user interface, to set the geospatial location associated with the first user interface as an anchor location of the anchored first digital place, wherein the updated map is stored on the non-transitory computer-readable storage. In some embodiments, the circuitry is further configured for or the method further comprises: receiving a user input from the second user interface to visit the anchored first digital place; and presenting, based on the user input from the second user interface, at least some aspect of the first digital place, the at least some aspect of the first digital place to be displayed via a display of the second user interface.

In some embodiments, the circuitry is configured for or the method further comprises: receiving input data from one or more user interfaces, wherein: the input data comprises a plurality of images of a first physical place at a first geospatial location, and the plurality of images captured by one or more cameras of the one or more user interfaces when located at the first geospatial location; performing image processing or analysis on the input data to: stitch together the plurality of images into one or more coherent images of the first physical place or generate a point cloud based on the plurality of images; determining three-dimensional (3D) data for the first physical place based on the one or more coherent images of the first physical space or based on generated point cloud; and performing 3D reconstruction or 3D modeling to shape the first digital place based on the 3D data, wherein the plurality of images and one or more parameter values for the shaped first digital place are stored by the non-transitory computer-readable storage, wherein: one or more visually perceptible traits of the shaped first digital place are based on the stored one or more parameter values for the shaped first digital place, and the one or visually perceptible traits of the shaped first digital place are to be displayed via the display of the user interface. In some embodiments, the circuitry is configured for or the method further comprises: hosting a map program that maintains a map, wherein the shaped first digital place is anchored to an anchor location on the map; receiving a user input from the user interface to visit the anchored shaped first digital place; and presenting, based on the user input from the user interface, at least some aspect of the shaped first digital place, the at least some aspect of the shaped first digital place to be displayed via the display of the user interface.

In some embodiments, the circuitry is configured for or the method further comprises: hosting a map program that maintains a map; receiving input data from a first user interface, wherein: the input data comprises a first elevation entry for the first digital place at a first geospatial location, and the first elevation entry indicates an elevation of the first user interface when located at the first geospatial location; updating the map, based on the input data from the first user interface, to set a first elevation of the first digital place at the first geospatial location, wherein the map updated with the first elevation is stored by the non-transitory computer-readable storage. In some embodiments, the circuitry is configured for or the method further comprises: receiving input data from a second user interface, wherein: the input data comprises a second elevation entry for the first digital place at the first geospatial location, and the second elevation entry indicates an elevation of the second user interface when located at the first geospatial location; and updating the map, based on the input data from the second user interface and based on the first elevation of the first digital place at the first geospatial location, to set an updated elevation of the first digital place at the first geospatial location, wherein the map updated with the updated elevation is stored by the non-transitory computer-readable storage.

Further scope of applicability of the present invention will become apparent from the Detailed Description given below. However, it should be understood that the Detailed Description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification.

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. In the drawings:

FIG. 1 illustrates an exemplary embodiment of a digital place 100.

FIG. 2 illustrates an exemplary embodiment of a system 200 operating digital places.

FIG. 3 illustrates an example screen layout 300 with building and/or editing tools for digital places.

FIG. 4 illustrates an exemplary embodiment of a digital-place object 400 as a hub for integrating with external services.

FIG. 5 illustrates an exemplary embodiment of a real-world geospatial location 500 with a digital-place anchor.

FIG. 6 illustrates an exemplary embodiment of shaping a digital place based on input data about a real-world geospatial location.

FIG. 7 illustrates an exemplary embodiment of anchoring a digital place 701 at a real-world geospatial location 700 and visiting the digital place 701.

FIG. 8 illustrates an exemplary embodiment of obtaining z-coordinate data of a digital place 701 at a real-world geospatial location 700.

FIG. 9 illustrates an exemplary embodiment of a digital place 100 as a hub for traversing through different digital places and/or digital worlds.

FIG. 10 is a circuit diagram of one aspect of a computing device 1000 that works in conjunction with the elements of the present disclosure.

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

This disclosure is not limited to the particular systems, devices and method described, as these may vary. The terminology used in the description is for the purpose of describing the particular versions or embodiments only, and is not intended to limit the scope. Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

Descriptions of well-known starting materials, processing techniques, components and equipment may be omitted so as not to unnecessarily obscure the invention in detail. It should be understood, however, that the detailed description and the specific examples, while indicating (e.g., preferred) embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer-readable medium (e.g., a hard disk drive, flash drive or other memory), hardware circuitry or the like, or any combination.

Before discussing specific embodiments, embodiments of a hardware architecture for implementing certain embodiments is described herein. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylus, etc.) or the like. In various embodiments, the computer has access to at least one database over the network.

ROM, RAM, and HD are computer memories for storing data and computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

The following terms shall have, for the purposes of this application, the respective meanings set forth below.

A “user” refers to one or more entities or people using any of the components and/or elements thereof as described herein. In some embodiments, the user may be a user of an electronic device. In other embodiments, the user may be a user of a computing device. Users described herein are generally either creators of content, managers of content, and/or consumers. For example, a user can be an administrator, a developer, a group of individuals, a content provider, a consumer, a representative of another entity described herein, and/or the like.

An “electronic device” refers to a device that includes a processor and a tangible, computer-readable memory or storage device. The memory may contain programming instructions that, when executed by the processing device, cause the device to perform one or more operations according to the programming instructions. Examples of electronic devices include personal computers, supercomputers, gaming systems, televisions, mobile devices, medical devices, recording devices, and/or the like.

A “mobile device” refers to an electronic device that is generally portable in size and nature or is capable of being operated while in transport. Accordingly, a user may transport a mobile device with relative ease. Examples of mobile devices include pagers, cellular phones, feature phones, smartphones, smartwatches, wearable computers or interfaces thereof, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, and the like.

A “computing device” is an electronic device, such as a computer including a processor, a memory, and/or any other component, device or system that performs one or more operations according to one or more programming instructions. A computing device may be a mobile device.

A “user interface” is an interface which allows a user to interact with an electronic device, a mobile device, or a computing device. A user interface may generally provide information or data to the user and/or receive information or data from the user. The user interface may enable input from a user to be received by the device and may provide output to the user from the device. Accordingly, the user interface may allow a user to control or manipulate a device and may allow the device to indicate the effects of the user's control or manipulation. The display of data or information on a display or a graphical user interface is a non-limiting example of providing information to a user. The receiving of data through a keyboard, mouse, trackball, touchpad, pointing stick, graphics tablet, joystick, gamepad, webcam, headset, gear sticks, steering wheel, pedals, wired glove, dance pad, remote control, and accelerometer are non-limiting examples of user interface components which enable the receiving of information or data from a user. A user interface may arbitrate and include communication between a user and an electronic device 1000. For example, the user interface may include input interfaces such as a keypad, a button, a touch screen, a touch pad, a gyroscope sensor, a vibration sensor, and an acceleration sensor.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “e.g.,” “in one embodiment.”

Although the figures and the descriptions described herein may be referred to using language such as “one embodiment,” or “certain embodiments,” or “example embodiments,” or “at least one embodiment” etc., these figures, and their corresponding descriptions are not intended to be mutually exclusive from other figures and/or descriptions, unless the context so indicates. Therefore, certain aspects from certain figures may be the same as certain features in other figures, and/or certain figures may be different representations or different portions of a particular exemplary embodiment, and/or certain aspects may be used with other aspects even if not explicitly mentioned, etc. Furthermore, any feature disclosed in one embodiment may be useable in any other embodiment.

Prior efforts in bridging the real world and a digital world have included attempts to add Augmented Reality (AR) technology to enhance an overlay an existing digital world (e.g., computer game) over portions of the user's real world. For example, digital images for a video game may be overlaid onto real-world objects or backgrounds presented on the display of a mobile device.

With this present disclosure, a user's digital place having a digital space (e.g., a digital personal room or digital housing enclosure structure) can be customized. For example, digital objects (e.g., furniture, artwork) in the digital space can be added or modified. Among other uses, the digital place can operate as a hub for the user to enter or access other digital worlds or games. In the real world, the user can anchor the digital place to a real-world location. Via the anchored digital place, the user can add AR enhancements to a digital representation of the corresponding real-world location. The digital place may be a decentralized digital asset owned by the user, for instance a digital room authenticated by an NFT stored on a distributed ledger, such as the ETHEREUM, AVALANCHE, or SOLANA blockchains (including multi-layer approaches). Embodiments of such digital places may be referred to as METAGATES in the present disclosure.

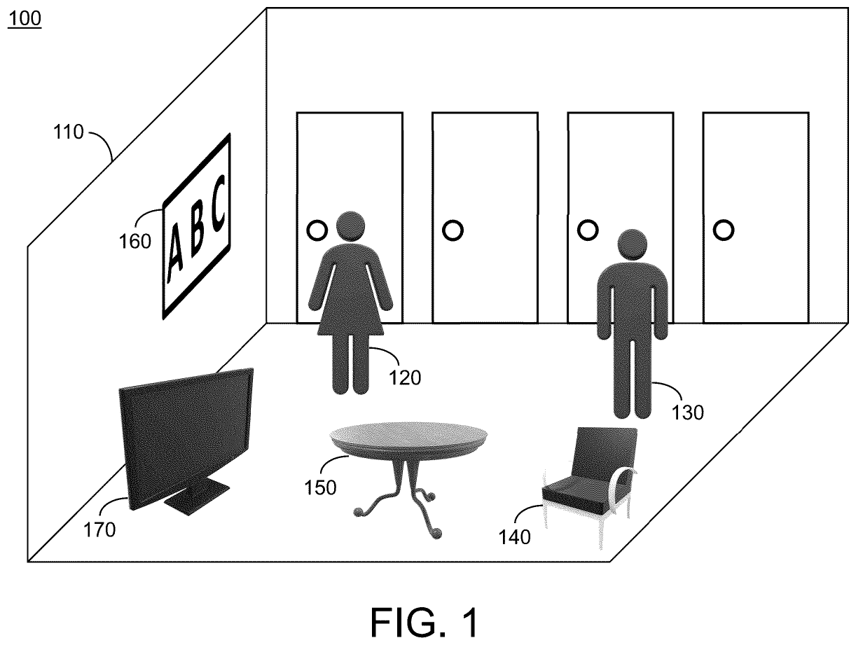

FIG. 1 illustrates an exemplary embodiment of a digital place 100. The digital place 100 can be embodied as a digital space 110 of any shape or volume (e.g., a single room, a multi-room apartment or condo or house or office) in virtual reality (VR) or augmented reality (AR) or mixed reality (MR) or in any combination of VR, AR, and/or MR. A user may navigate through the digital space 110 in a first-person POV or a third-person POV. In a first-person POV, a first user of the digital place 100 may directly view the interior of the digital space 110, as though looking into a viewing window through the first user's UI (e.g., display screen of a laptop computer, desktop computer, tablet computer, smartphone, heads-up display (HUD), headset, smart glasses). In a third-person POV, a first user of the digital place 100 may use an avatar 120 in the digital space 110 with a camera view slightly behind the avatar 120, as though looking into the camera view through the first user's UI. When facing an avatar 130 of a second user, the first user's view shows the avatar 130. When facing the avatar 120 of the first user, the second user's view shows the avatar 120.

A user's UI may show the user's POV in the digital space 110 via a web browser or a dedicated app. A first user may be the owner of digital place 100, and she may invite a second user to join her in digital space 110 of digital place 100. The first user may share access to digital place 100 by sending an access link (e.g., a link to an internet website, a link to a private server, etc.) to the second user by, for examples, email or text message or other notification. When the first user and the second user are both accessing the same digital place 100, each user may see the other user's avatar. The two users can communicate with each other via voice, video, and/or text chat as in an online meeting. The owner of digital place 100 can set communication permissions, such as only her audio is permitted to speak to a group of other users for a share-only speech or presentation. To collaborate on a project, digital place 100 may include productivity tools, such as a common whiteboard that users can collaboratively use.

When anchored to a geographical location in the real world, digital place 100 may be accessed via an object or marker at that geographical location. That object or marker may be visible on a map program that recognizes digital place 100, such as through a web browser or a dedicated app. That object or marker may be visible through a camera of a user's UI (e.g., of a smartphone, computer, HUD, headset, smart glasses, etc.) running a map program that recognizes digital place 100, such as through a web browser or a dedicated app. The user can access digital place 100 and enter into digital space 110 by interacting with that object or marker on a map program, in AR (e.g., a link shown on or around the object or marker on a touchscreen), or in MR (e.g., picking up, grabbing, touching, or other gesture with the object or marker).

Inside digital space 110, a user can navigate via suitable operators (e.g., arrow keys on a keyboard, touch gestures on a touchscreen, moving a joystick on a handheld controller, etc.) on the user's UI. For examples, a user can move directly in first-person POV or as an avatar 120 in third-person POV within digital space 110, sit on chair 140, jump on table 150, or approach artwork 160 on the wall. The user can also change the view via suitable operators (e.g., moving a computer mouse, touch gestures on another touchscreen, moving another joystick on a handheld controller, etc.). With permission (e.g., by the owner, by an authorization setting), a user can modify aspects of digital place 100. For example, a user can grab and place TV 170 on the floor or on table 150 via suitable operators (e.g., assigned keys on a keyboard, hand gestures detectable by gyro sensors and/or accelerometer of a smartphone, buttons on a handheld controller, etc.) on the user's UI. A user can modify aspects of an object, for example, increasing or decreasing the size of table 150 via suitable operators (e.g., assigned keys on a keyboard, scroll wheel on a computer mouse, interacting with a pop-up window of table properties, etc.).

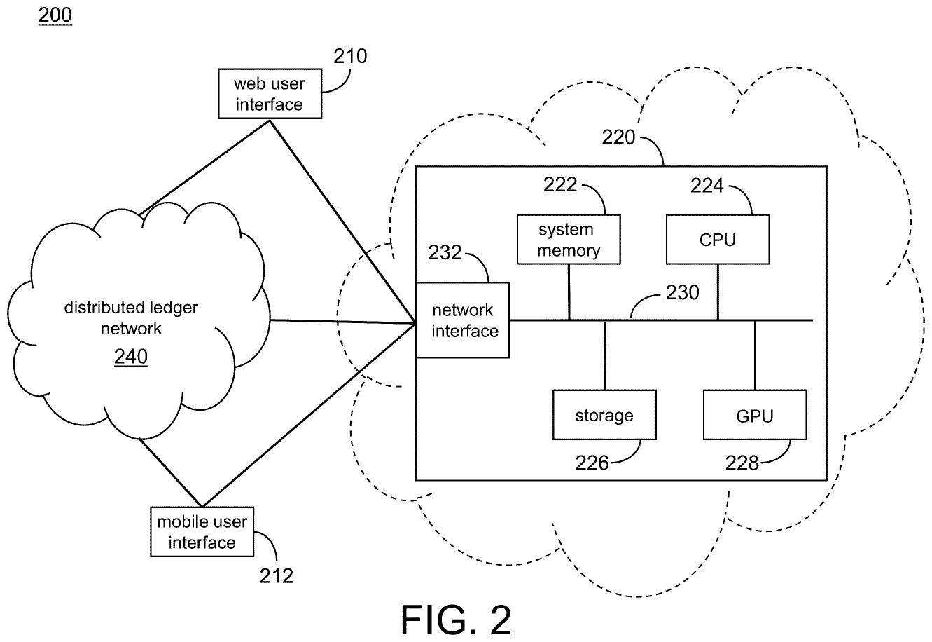

FIG. 2 illustrates an exemplary embodiment of a system 200 operating one or more digital places. System 200 can embody equipment and services for generating, maintaining, and operating digital places. System 200 can perform services that host the one or more digital places via circuitry 220, which circuitry may be implemented in one or more stand-alone computers, in a cloud computing network, or other suitable computing device, etc. The circuitry 220 may include storage 226 (e.g., hard drive(s), solid-state drive(s), other storage media, database(s), combination of storage devices) to store data, such as the data of digital places (e.g., various parameters and specific parameter values indicating, defining, or describing relationships between object dimensions, relative dimensions, object traits, décor, furnishings, wall color, wall pattern, object origin, object ownership, portals, digital place origin, digital place ownership, related servers, rendering history and details, related processors, etc.), system software, cloud software, data for a machine learning model(s), digital-place map data (e.g., elevation, GPS data), etc. This storage 226 may include one or more storage medium devices that store data involved in the operation of and interaction with digital places. Circuitry 220 may include circuitry 224, e.g., one or more central processing units (CPUs) including one or more main processors, to execute software or firmware or other kinds of programs that cause circuitry 220 to perform the functions of circuitry 220. The inventor(s) consider processors to include any, or a combination, of discrete componentry, microprocessor(s), microcontroller(s), programmable logic device(s), programmable gate array(s), ASIC(s), digital signal processor(s), or the like, configured to process instructions. Circuitry 220 may include circuitry 228, e.g., one or more graphics processing units (GPUs), to perform functions for machine learning. The CPU(s) and GPU(s) may perform functions involved in the operation of and interaction with digital places. Throughout this disclosure, functions performed by GPU(s) 228 may also be performed by CPU(s) 224 or by GPU(s) 228 and CPU(s) 224 together. Circuity 220 may include system memory 222 (e.g., RAM, ROM, flash memory, or other memory media) to store data, such as data to operate circuitry 220, data for an operating system, data for system software, data for cloud software, etc. Some or all of the components or elements of circuitry 220 may be interconnected via one or more connections 230, such as buses, cables, wires, traces, network connections (e.g., wired, wireless), etc.

Users of system 200 can interact with the digital-place operation and interaction functions. Circuitry 220 may connect to a web user interface 210 and/or to a mobile user interface 212 (each typically including, but not limited to, one or more display screens) via communications through a network interface 232. Web user interface 210 and mobile user interface 212 may include user interface(s) and display(s) to receive inputs from and/or provide outputs to the user(s). Such user interface(s) may include, e.g., manual operators such as button(s), rotary dial(s), switch(es), touch surface(s), touchscreen(s), stylus, trackpad(s), mouse, scroll wheel(s), keyboard key(s), etc.; audio equipment such as microphone(s), speaker(s), etc.; visual equipment such as camera(s), light(s), photosensor(s), etc.; environment sensing equipment such as LIDAR, gyro sensors, accelerometers, GPS units, etc.; and/or any other conventional user interface equipment. Displays of web user interface 210 and mobile user interface 212 may be housed or integrated with element(s) of external devices, such as in a monitor or a panel display that includes a touchscreen, microphone, speakers, and a camera, to receive user inputs and to provide system outputs to a user. Such display(s) can graphically present activity related to the digital-place operation and interaction functions. Web user interface 210 may be part of a computing device such as a laptop computer or desktop computer. Mobile user interface 212 may be part of a mobile device such as a smartphone or mobile computing headset.

In some embodiments, circuitry 220 may store, or be hard-coded with, instructions constituting an operating system or cloud software to run operations of circuitry 220. In some embodiments, circuitry 220 may include circuitry, e.g., FPGA or ASIC, or some combination of hardware circuitry and software to run operations of circuitry 220. Via some or all of the above components, circuitry 220 can receive user inputs and perform digital-place operation and interaction functions.

Circuity 220 may be implemented in various form factors and implementations. For example, circuitry 220 can be deployed on one or more local machines such as a PC or workstation. As another example, circuitry 220 can be deployed in one or more servers among one or more data centers. As yet another example, circuitry 220 may be deployed in one or more servers in a secure public cloud or a private could. Users may access such local and/or remote circuitry 220 through a web user interface or mobile user interface.

A digital place's visual appearance and interactive experience may be provided via a three-dimensional (3D) experience platform, such as a 3D experience engine and/or a 3D video game engine. Such a 3D experience platform may be provided by circuitry 220 embodied as a server running one or more corresponding program(s) stored in storage 226 and/or system memory 222. The server can run one or more programs to generate, maintain, and operate digital places on the 3D experience platform, and the digital places may be accessible by users via, e.g., a web browser or a dedicated app. A user can operate and interact with digital places such as digital place 100 via, e.g., web user interface 210 or mobile user interface 212. A digital place's visual appearance and interactive experience may be rendered at the server-side (e.g., at circuitry 220) or at the client-side (e.g., at web user interface 210 or mobile user interface 212) or via a combination of processes at both the server-side and the client-side. Server-side activity (e.g., loading a digital place 100, rendering a digital space 110, storing/saving changes about digital place 100 or digital space 110, etc.) may result in a faster experience for a user due to several technical aspects. For example, the server (e.g., its hardware and software) may pre-load and/or pre-render elements for the user's client to simply access when starting; thus, there is less work for the client-side user's hardware to do when starting. As another example, the server can manage synchronization of user-experiences by different users; thus, client-side users' hardware are not burdened with such management tasks. Client-side activity (e.g., rendering a digital space 110 in accordance with a user's preferences) may be useful for some aspects. For example, the client (e.g., its hardware and software) may have a local cache(s) or store cookie(s) that can store data related to a user's local or short-term activity (e.g., preferences, pre-set configurations, recent history, etc.); thus, the client-side user's hardware needs not obtain such data from the server, which can result in a smoother experience for a user by avoiding reliance on the server for such data. Combination of processes at both the server-side and the client-side can incorporate advantages and benefits of both.

Ownership of digital places may be obtained, maintained, and/or authenticated via digital ledger operations (using, e.g., the ETHEREUM blockchain) stored in a distributed ledger network 240. For example, ownership of digital place 100 may be linked to a unique digital token, e.g., an NFT stored on-chain at a unique digital address such as an address on the ETHEREUM blockchain (or at a unique identifier among other identifiers that all share the same ETHEREUM address) belonging to the owner of digital place 100. That unique ETHEREUM address may be provided to the owner. In some embodiments the unique ETHEREUM address may be stored in the owner's digital wallet. As an example use case, when the owner of digital place 100 at web user interface 210 opens a web browser at the website address of the digital-place service hosted by circuitry 220 as a remote digital-place server, the server can prompt the user or give the user an option to connect her digital wallet to the server. Her digital wallet may have the ownership NFT for authentication of the digital place 100 at the wallet's (e.g., ETHEREUM) address in distributed ledger network 240. The owner can check her wallet's contents by using her web user interface 210 to communicate with distributed ledger network 240 to show her the wallet's contents on her browser screen, including the ownership NFT for the digital place 100. When connected to the digital wallet, the digital-place server (circuitry 220) can communicate with distributed ledger network 240 to check whether the wallet does contain the ownership NFT for digital place 100. Via her browser, the owner can mouse-click or finger-tap her digital place 100 listed or shown on the digital-place service website in order to access or enter digital place 100. When the digital-place server (circuitry 220) determines that her wallet does contain the correct ownership NFT for digital place 100, the server can show the user the digital space 110 in first-person POV or third-person POV on the display of her device. If the user or wallet does not provide an appropriate NFT, then the server declines or blocks the user from accessing or entering the digital place 100, such as when the user mistakenly tries to enter an unauthorized (e.g., unowned) digital place. Thus, unauthorized users cannot simply wander into a random digital place 100 and rearrange the furniture. In some embodiments, for users that lack the correct ownership NFT for digital place 100, the server may still permit entry into digital place 100 to only view and navigate through digital space 110 without any ability to modify any aspect of digital place 100. By incorporating digital-ledger technology (e.g., NFT technology), digital places of this disclosure can introduce technological improvements, including improved data security (e.g., unalterable and persistent on-chain data stored on digital ledger network), improved data transparency (e.g., single immutable unitary ledger of digital ledger network), improved tracking of digital assets (e.g., immutable activity history of digital ledger network), faster speed and more efficiency (e.g., unnecessary to perform tasks of reconciling multiple ledgers when digital assets move), automation capabilities (e.g., NFT token-gating where digital access can be automatically provided to various user's hardware/software based on NFT movement), etc.

In addition to its graphical and interactive features, a digital place 100 may include one or more default parameter values, such as a date or other identifier representing when the owner first obtained ownership of the digital place 100. Based on the default parameter values, the digital-place server (circuitry 220) can show the digital place 100 as having some default traits or default features such as default décor, furnishings and/or a default wall color. After the owner takes ownership by obtaining an ownership NFT for digital place 100 (e.g., in her digital wallet), she can introduce modifications to the various traits or features of the digital place 100. For instance the owner may add or remove furniture, change wall color or pattern, add or remove portals (e.g., doors), etc., each of which may correspond to a modified parameter value. As long as the user holds the ownership NFT for digital place 100, the digital-place server (circuitry 220) can save her modifications as her personal data for digital place 100. The owner's personal data for digital place 100 may be stored in storage 226, e.g., a backend database that links the digital place 100 to the current owner's personal data. When the user transfers (e.g., sells) the ownership NFT for digital place 100 to another user, such as by transferring the NFT to the new user's digital wallet, then the digital-place server (circuitry 220) can reset the parameters of digital place 100 to its default parameter values. In some instances, the system may detect the change in ownership and automatically reset the parameters. In other embodiments, the former or current owner of the ownership NFT may choose to reset the parameters upon transfer of ownership, or may initiate transfer of one or more digital assets associated with the digital place 100 (e.g., décor, artwork, furnishings, avatars, portal designs, etc.)

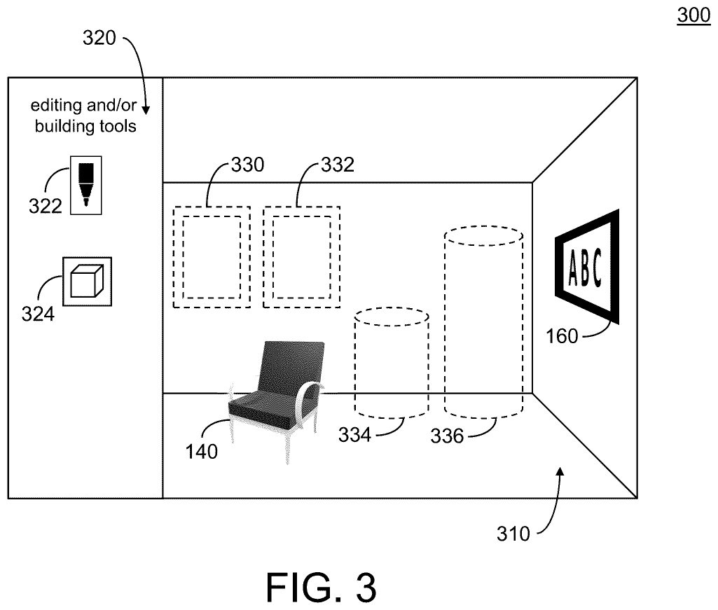

FIG. 3 illustrates an example screen layout 300 with editing and/or building tools for digital places. After a user obtains ownership of a digital place (e.g., by buying or minting or receiving an ownership NFT), the user can customize the newly obtained digital place. For example, right-side panel/toolbar 310 may include editing and/or building tools for digital place elements in main panel 320. A user can modify visual aspects (e.g., color, texture, etc.) of a selected element (e.g., chair 140, wall, ceiling, floor) via a drawing tool 322. A user can add or remove objects (e.g., furniture, digital artwork, importable NFT assets, etc.) to digital space inside a digital place via an object tool 324. Alternatively, instead of right-side panel/toolbar 310, a user can edit or build for the digital place on the fly via, e.g., shortcut keys or key sequences on a keyboard, right-click for a pop-up edit/build menu, click-and-drag objects from external windows into the browser window of the digital-place service website, etc.

When importing NFT assets into a digital place, the digital-place server (circuitry 220) can place NFT assets in the digital space, such as in a showcase gallery. Two-dimensional (2D) NFT assets (e.g., digital art images, digital video clips, etc.) may be placed in frames 330 and 332. 3D NFT assets (e.g., digital clothing, video game weapon, video game avatar, etc.) may be placed in cases 334 and 336. In order to import her NFT assets into digital place 100, an owner at web user interface 210 may select one or more of her NFT assets in her digital wallet via a web browser. The web user interface 210 may be communicating with distributed ledger network 240 to view the contents of the digital wallet and also communicating with the digital-place server (circuitry 220) to instruct the digital-place service website to import one or more of her NFT assets in the digital wallet. The digital-place server (circuitry 220) may communicate with distributed ledger network 240 to retrieve the NFT asset(s) stored on-chain in distributed ledger network 240 or off-chain in another storage location at an address where data of the NFT asset(s) may indicate via a link or another kind of pointer. The digital-place server (circuitry 220) can import the NFT asset(s) as objects in the digital space of the digital place. In the digital space, the owner and other users may view or experience the NFT asset(s) in a communal and shared manner.

Ownership of assets inside digital places may also be conducted via distributed ledger network(s) 240, for example, the ETHEREUM blockchain. For examples, the 2D and 3D NFT assets for frames 330 and 332 and cases 334 and 336 may be additional digital assets that belong to the owner of digital place 100. Some or all of the other objects in the digital space of digital place 100 may be NFT asset(s) that can be used outside of digital place 100. The same digital wallet may hold the corresponding authenticating NFTs along with the ownership NFT of digital place 100. Some or all of the other objects in the digital space of digital place 100 may be native and limited to usage in digital place 100.

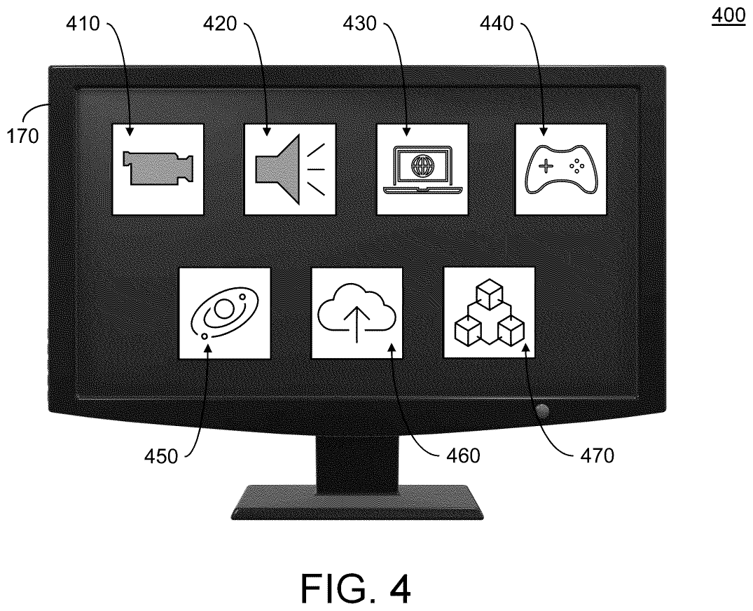

FIG. 4 illustrates an exemplary embodiment of a digital-place object 400 as a hub for integrating with external services. In addition to importing external digital assets such as NFT assets, digital place 100 can integrate external services, such as video streaming content services and audio streaming content services. For example, digital place 100 may integrate external services into digital space 110 via a digital-place object 400 such as TV 170. A user can login to a video streaming content service 410 accessible on the screen of TV 170 and view the video content on TV 170, viewable at the user through, e.g., a screen at web user interface 210 or mobile user interface 212. A user can login to an audio streaming content service 420 accessible on the screen of TV 170 and listen to the audio content while inside the digital space 110, audible to the user through, e.g., speakers or earphones at web user interface 210 or mobile user interface 212.

A user can browse websites from within the digital place 100 by selecting an internal service, e.g., an internal web browser 430 on the screen of the TV 170 and view and/or hear web content on the TV 170. A user can play games, such as, but not limited to, classic mini-games, from within the digital place 100 by selecting video game option 440 on the screen of TV 170 and view and/or hear game content on TV 170. A user can explore various digital worlds from within the digital place 100 by selecting a digital world option 450 on the screen of TV 170 and view and/or hear content from the digital world on TV 170. A user can upload various digital content (e.g., image files, video files, sound files, multimedia files, 3D models, PDF files, office productivity files, etc.) from within digital place 100 by selecting an internal service, e.g., an internal upload option 460 on the screen of the TV 170, and can view and/or hear uploaded content on the TV 170. A user can import unique digital assets (e.g., distributed ledger-authenticated assets, NFTs, NFT-authenticated assets, NFT-token-gated assets (e.g., asset(s) that is inaccessible until one possesses a certain NFT as an access key), etc.) from within digital place 100 by selecting distributed-ledger asset option 470 on the screen of the TV 170 and view and/or hear imported unique digital assets on TV 170.

For integrating external services, the digital place 100 may serve to provide an adaptive synthesizer that generates viewing/listening/interaction mediums of those external services, in ways optimized for digital place 100. For example, the digital place 100 may be based on a native application platform by a native application provider and the external services may be based on other application platforms by other application providers, where the other application platforms are different from the native application platform of the digital place 100. The digital place 100 may use Application Programming Interfaces (APIs). For example, the digital place 100 may use or integrate a YOUTUBE API when the video streaming content service 410 includes YOUTUBE, so that a user may login to her YOUTUBE account via the video streaming content service 410. As another example, the digital place 100 may use or integrate a SPOTIFY API when audio streaming content service 420 includes SPOTIFY, so that a user may login to her SPOTIFY account via the video streaming content service 420. Alternative to approaches using APIs directly, the digital place 100 may access (e.g., via APIs or not) and cache content from external services and then synthesize a custom viewing/listening/interaction user-interface that can deliver that cached content to a user. By integrating external services, digital places of this disclosure can introduce technological improvements, including streamlined aggregation of multiple external services, cross-provider and/or cross-platform integration into a one-stop hub, etc.

While FIG. 4 and the above examples disclose options 410-470 on a TV 170 and presenting of content via the TV 170, some embodiments may disclose options 410-470 on other digital-place objects, such as a PC object or a laptop object displayed within the digital space 110. Some embodiments may present content via other digital-place objects, such as a PC object or a laptop object. Some embodiments may disclose options 410-470, not via a digital-place object such as TV 170, but on a system menu (e.g., accessible via keyboard strokes, mouse-clicks, touchscreen taps, game controller button, etc.) directly on a physical screen at web user interface 210 or mobile user interface 212. Some embodiments may present content, not via a digital-place object such as TV 170, but via directly on a physical screen at web user interface 210 or mobile user interface 212.

Digital-place objects in digital space 110 can be modifiable in a manner that is smooth and fast to a user. To provide or promote this smooth and fast experience in modifying digital-place objects, various objects may be generated according to certain classifications. For some examples, there can be a decoration class, a furniture class, a NFT asset container class, etc. In the decoration class, there can be a chandelier object. In the furniture class, there can be a chair object, a couch object, a table object, a TV object, etc. In the NFT asset container class, there can be a 2D rectangular frame object, a 2D oval frame object, a 3D standing case object, a 3D wall-mounted case object, etc. For the digital-place objects in the digital space 110, basic digital world aspects (e.g., gravity, image rendering quality) can be provided by a three-dimensional (3D) experience platform, such as a 3D experience engine and/or a 3D video game engine.

Each type of object can have certain traits that permit certain modifications or interactions, as in the following examples. A chandelier object may have a trait of only being hung from or attached to a ceiling. Furniture class objects may all have a trait of being placeable on the ground, a trait of being moveable, and a trait of changeable color, but only some objects (e.g., a chair object, a couch object, a table object) may have a trait of being changeable in size and a trait of supporting avatars on them. Some objects such as a TV object or a PC object or a laptop object can have a trait of having additional interactive functions, such as the video, audio, browser, and game functions exemplified in FIG. 4. The 2D NFT asset container objects can have a trait of displaying 2D image files (e.g., personal PFP profile images or photos) and a trait of automatically sizing them to fit the frame size and shape of the respective 2D NFT asset container object. The 3D NFT asset container can have a trait of displaying 3D object files (e.g., digital sculpture, plant, animal, video game weapon, armor, tool, avatar) and a trait of automatically sizing them to fit the case size and shape of the respective 3D NFT asset container object.

By employing certain classifications, types of customizations for the digital-place objects can be limited, thus reducing computational calculations that digital-place server(s) (circuitry 220) need to perform to generate and maintain the digital space experience of the objects in the digital place. In contrast, other techniques of digital world rendering based on full world physics for each pixel in a digital space can require massive amounts of computations. The above classifications for the digital-place objects can avoid such large amounts of computations, thus providing or promoting smooth and fast experiences in modifying digital-place objects. Technically distinct from merely displaying a list (e.g., as in a simple digital wallet) of digital objects (including NFT assets and non-NFT assets), digital places of this disclosure can provide further practical technological applications with digital objects, including enabling a shared experience where multiple users can view, experience, and/or manipulate digital objects with synchronized traits, synchronized multimedia, and/or synchronized placements in 3D environments.

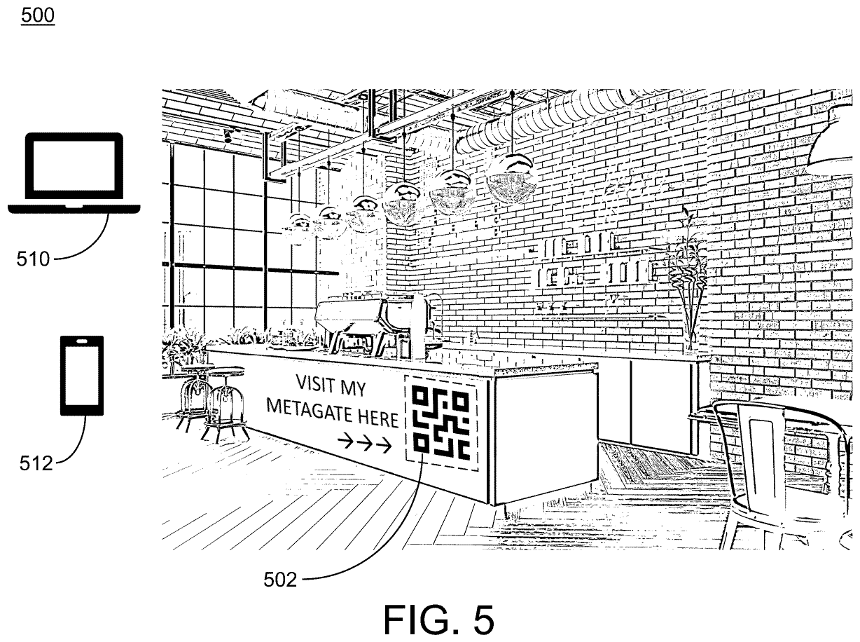

FIG. 5 illustrates an exemplary embodiment of a real-world geospatial location 500 with a digital-place anchor. Here, the digital-place anchor fixes (or “anchors”) a particular digital place to a real-world geospatial location. In the example illustrated in FIG. 5, real-world geospatial location 500 is a coffee shop, and a digital-place anchor is embodied as a quick response (QR) code 502. Users can scan QR code 502 with cameras linked to a web user interface 510 such as a laptop or a mobile user interface 512 such as a smartphone. The laptop or the smartphone may have a QR code reader circuitry or functionality that interprets QR code 502 as, or as including, a network address (e.g., a website link) of a corresponding digital place anchored to that geospatial location 500. QR code 502 may be a physical object such as a physical sticker or a physical printed sign, or may be an AR or MR object that is visible through a camera linked to a computing device 510 or mobile device 512 running a digital-place app or browsing a digital-place website. Digital-place anchors may be embodied in a number of additional or alternative ways. For example, a digital-place anchor may be implemented by bar code, APPLE AIRTAG, WiFi login screen options, geofencing triggers, and the like. To enter and visit that corresponding digital place, users may mouse-click or finger-tap the website link on their user interfaces. The digital-place server (circuitry 220) hosting the digital-place anchored to geospatial location 500 may present that digital place to those visiting users, which may be an extra virtual room for that coffee shop.

The digital-place anchored to real-world geospatial location 500 of a coffee shop may be embodied as a virtual room having some default parameter values corresponding to default features such as default room size, shape, color, furniture, etc. Alternatively, or additionally, the digital-place server (circuitry 220) can receive input data to shape the digital place's virtual room to match a corresponding real-world room (e.g., 1:1 overlay) or otherwise have similarities to the real-world room of the coffee shop at real-world geospatial location 500.

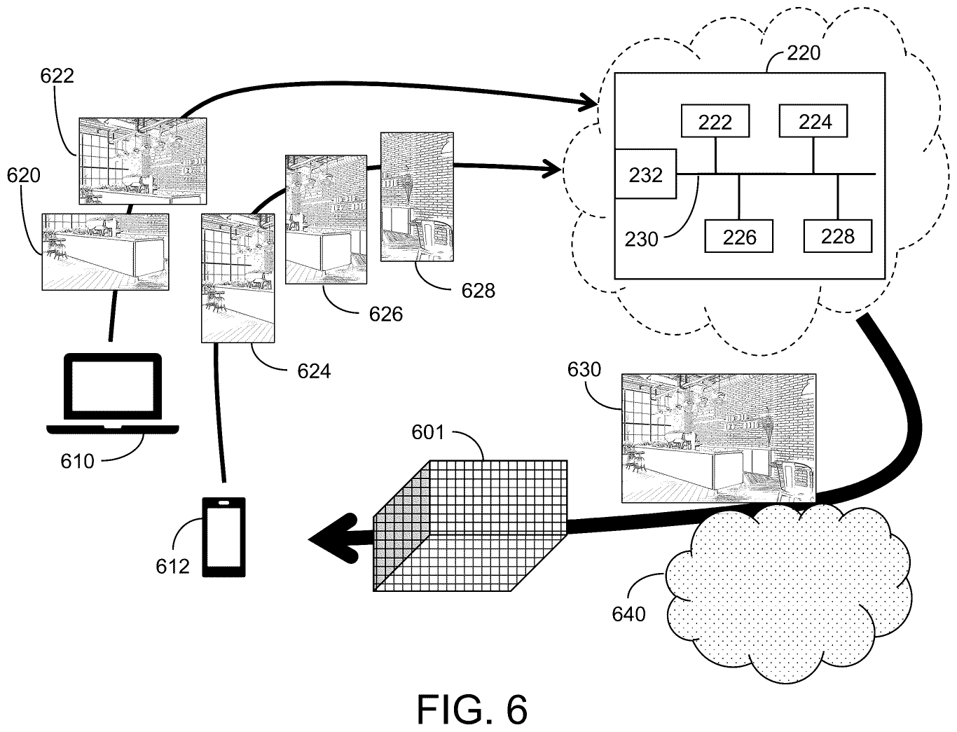

FIG. 6 illustrates an exemplary embodiment of shaping a digital place 601 based on input data about a real-world geospatial location. This input data may come from crowdsourced data such as photos 620, 622, 624, 626, 628 of the real-world room captured at geospatial location 500 by one or more users, e.g., via a web user interface 610 or a mobile user interface 612. The crowdsourced data may include geotag metadata stored in or in association with one or more of the photos. The digital-place server (circuitry 220) may perform image processing and/or analysis on the input data to stitch together photos of the real-world room at geospatial location 500 into one or more larger coherent photos 630 of real-world room and/or to generate a point cloud 640 based on the photos and/or their geotag metadata. The point cloud may include a collection of data points in a 3D coordinate system. Each point in the point cloud may represent a specific point on a physical object or environment, and the collection of these points may create a digital representation of that object or environment. A machine-learning model application executed on GPU(s) 228 may perform the image stitching tasks. Based on the point cloud 640 and/or the larger coherent photos 620, the digital-place server (circuitry 220) can determine points of interest for effectively performing 3D scanning of the real-world room. From the available 3D data, digital-place server (circuitry 220) can perform 3D reconstruction or 3D modeling to shape the virtual room of digital place 601 to match (e.g., 1:1 overlay) or be similar to the real-world room of the coffee shop at real-world geospatial location 500. The digital-place server (circuitry 220) hosting a digital place 601 that is anchored to geospatial location 500 may present digital place 601, as shaped by input data from one or more users, to visiting users, e.g., via a web user interface 610 or a mobile user interface 612.

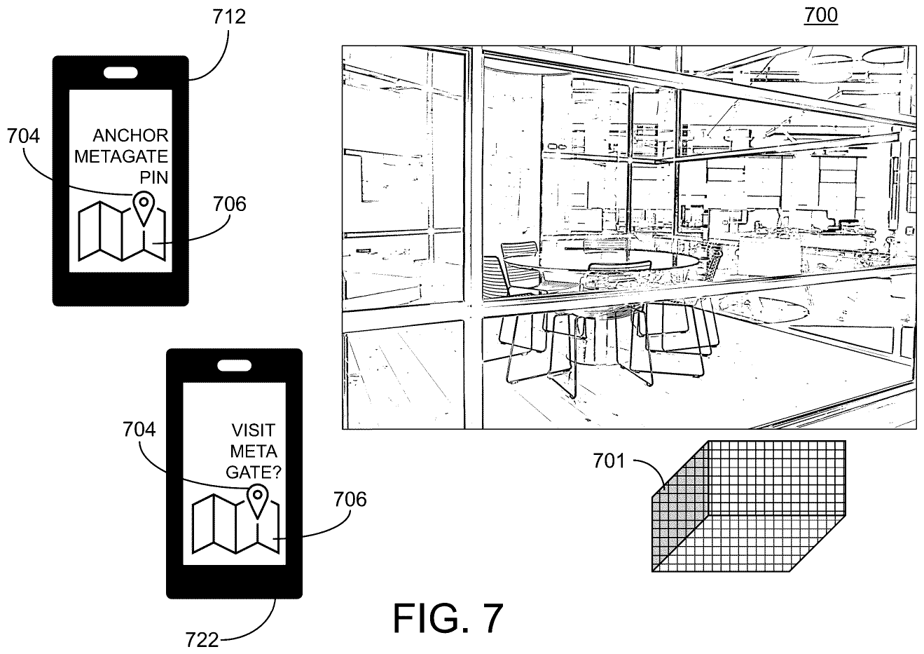

FIG. 7 illustrates an exemplary embodiment of anchoring a digital place 702 at a real-world geospatial location 700 and visiting the digital place 701. In this example, real-world geospatial location 700 is a business office, a digital-place anchor is embodied as a QR code 702, and digital place 701 is a digital office for the real-world business office. The owner of digital place 701 may anchor digital place 701 at geospatial location 700 by placing a digital-place pin 704 at the real-world geospatial location 700 on a map 706 of a map program that recognizes digital place 701. The map program may be run by a digital-place server (circuitry 220). The owner may use a first mobile user interface 712, such as her smartphone, to place the digital-place pin 704 on map 706 when she is physically at the real-world geospatial location 700. At a later time, another user may use a second mobile user interface 722, such as his smartphone, to visit digital place 701 when he is physically at the real-world geospatial location by finger-tapping the digital-place pin 704 on map 706. The owner may configure her digital place 701 to present an accessible digital office when the real-world business office is closed from physical access or entry outside of operating hours for the real-world business office. Other users may still conduct some useful activity via the digital office of digital place 701 even when the real-world business office is closed at geospatial location 700. The map program and the digital-place server (circuitry 220) may be configured to include anti-spoofing features to prevent users from using location spoofing to falsely pretend that they are physically at real-world geospatial location 700 to enter or access the anchored digital place 701.

According to an embodiment, a digital place 701 may present according to different selected configurations at different times. For example, the digital place 701 may appear as a business office during business hours, and as an art gallery during non-business hours. According to some embodiments, the digital-place owner may configure the digital-place's digital space to appear, for a particular visitor, different from the way the digital place appears to another user. According to an embodiment, the user or visitor may select from a number of predetermined themes, where one or more digital-place objects in the digital place can have an appearance or other property that corresponds to the selected theme. In this manner, the basic layout and spatial configuration of the digital place may be the same in each theme, but having different appearance properties at different times or for different simultaneous users.

Map 706 may provide services in x and y coordinates, such as the cardinal directions of north, south, east, and west. Map 706 may obtain x and y coordinate data from GPS positioning data and/or available base map services. Map 706 may also provide services in a z-coordinate direction to correspond with geographical elevations on mountains or tall office buildings or, in some embodiments, underground or underwater, or in outer space (relative to earth or another reference object).

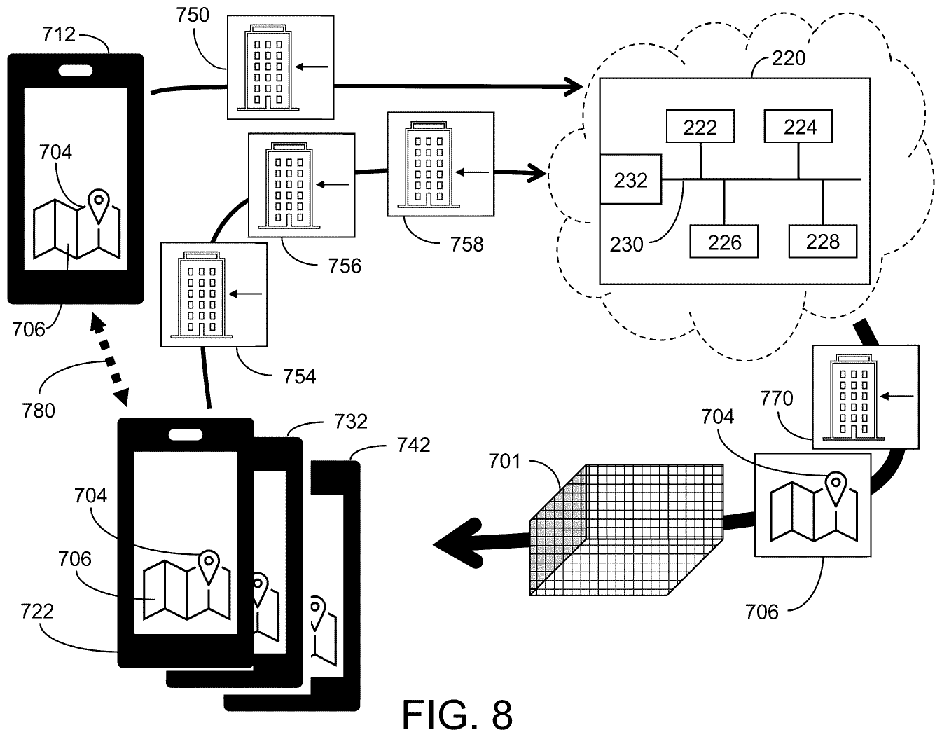

FIG. 8 illustrates an exemplary embodiment of obtaining z-coordinate data of a digital place 701 at a real-world geospatial location 700. To obtain z-coordinate data, the digital-place server (circuitry 220) may receive input data about elevations at real-world geospatial location 700. This input data may come from crowdsourced data such as an elevation entry 750 of the digital place 701 anchored at real-world geospatial location 700, submitted by the owner of the digital place 701 when setting its anchor at pin 704 on map 706. For example, the owner may conduct a LIDAR or other spatial scan of the environment via her smartphone 712 at the anchor location pin 704 on map 706 and enter the elevation at, e.g., the fourth floor, in order to set an initial reference scan with elevation, and then submit this input data 750 to the digital-place server (circuitry 220) running the map program. Based on the input data 750 including the owner's elevation entry, the digital-place server (circuitry 220) may obtain and set z-coordinate data of digital place 701 at real-world geospatial location 700. Subsequent users of the map program may see digital place 701 anchored at pin 704 on map 706 as having an elevation 770 of, e.g., the fourth floor entered by the owner.

Other users may conduct respective LIDAR scans of the environment and generate their elevation entries via their smartphones 722, 732, 742 at the anchor location pin 704 on map 706. These users can submit their input data 754, 756, 758 to the digital-place server (circuitry 220) running the map program. Based on the input data 754, 756, 758 including these users' elevation entries, the digital-place server (circuitry 220) may update z-coordinate data of digital place 701 at real-world geospatial location 700. For example, the digital-place server (circuitry 220) may determine an elevation 770 of, e.g., the fourth floor, with a confidence score of accuracy (e.g., some percentage of accuracy confidence) based on the number of coinciding elevation entries versus deviating elevation entries. Input data 750, 754, 756 may coincide on an elevation of the fourth floor, but input data 758 may have a deviating entry of an elevation of the third (not fourth) floor. Later users of the map program may see digital place 701 anchored at pin 704 on map 706 as having an elevation 770 of the fourth floor with an example confidence score of accuracy of 75% or more. Later users' input data including coinciding elevation entries (of the fourth floor) would increase the confidence score of accuracy. When later users' input data have a spatial (e.g., LIDAR) scan of the environment that fails to match other submitted scans of the environment for anchored digital place 701, the digital-place server (circuitry 220) may give lower weight or ignore such input data for determining the elevation 770 and/or the confidence score of accuracy.

Obtaining z-coordinate data of a digital place 701 at real-world geospatial location 700 may be achieved in alternative or additional ways, and is not limited to relying on matching LIDAR scans with elevation entries. For example, smartphones 712, 722, 732, 742 may communicate with each other in a manner 780 where they can cross-reference their digital-place elevation data when in close proximity, e.g., users in close proximity that can communicate via Internet-of-Things (IoT) sensors, equipment, protocols, network, etc. When one smartphone 712 introduces reference digital-place elevation data (e.g., fourth floor for digital place 701) to the pool of users' digital-place elevation data, then the system may be configured to propagate that reference digital-place elevation to smartphones 722, 732, 742, each of which may further subsequently spread that reference digital-place elevation data to other smartphones that use the map program. According to an embodiment, elevation data may be provided by one or more sensors of the user's mobile device or may be calculated or estimated based on sensor inputs. Elevation data may include a real-world distance above (or below) ground level, above (or below) sea level, or in some embodiments may include a more abstract description such as a building floor (e.g., “5th floor”).

At digital places, their digital spaces may be used to conduct a wide variety of activities. In FIGS. 1 and 3, digital space 110 of digital place 100 can exemplify a home environment where a user can watch TV, listen to music, or store and display NFT asset possessions. In FIGS. 5 and 6, the digital space of the digital place anchored at real-world geospatial location 500 can exemplify a store environment. In FIGS. 7 and 8, the digital space of the digital place 701 anchored at real-world geospatial location 700 can exemplify an office environment.

These above embodiments, however, are not limited to their features disclosed above. For example, digital space 110 of digital place 100 can be used as a marketplace or store environment, as well. In FIG. 3, each NFT asset container 330, 332, 334, 336 may contain an NFT digital asset (e.g., 2D photo, 2D digital artwork, 2D video clip, 3D sculpture, 3D plant, 3D animal, video game asset, avatar, readable book, etc.) that is available for sale by the owner of digital place 100 as the seller. A user who is the buyer can enter digital place 100 via, e.g., web user interface 210 or mobile user interface 212. The buyer can mouse-click or finger-tap NFT asset container 330 and its contained NFT asset may be selected for purchase. The buyer can pay the seller via online payment options, including via cryptocurrency through distributed ledger network 240. The ownership of the target NFT may transfer from the seller to the buyer via distributed ledger network 240 moving the target NFT from seller's digital wallet to the buyer's digital wallet.

For another example, the digital space of the digital place anchored at real-world geospatial location 500 may be an extra virtual room for a coffee shop, but that virtual room can facilitate activity in the real-world. A user who is a visitor can enter the anchored digital place via, e.g., web user interface 210 or mobile user interface 212. The virtual room may contain a digital menu for real items on sale in the coffee shop. In the virtual room, a visitor can order a cup of coffee and receive a digital order ticket in the form of, e.g., a QR code. The visitor can approach the physical sales counter, show the QR code to a cashier at the counter, and pick up the ordered cup of coffee.

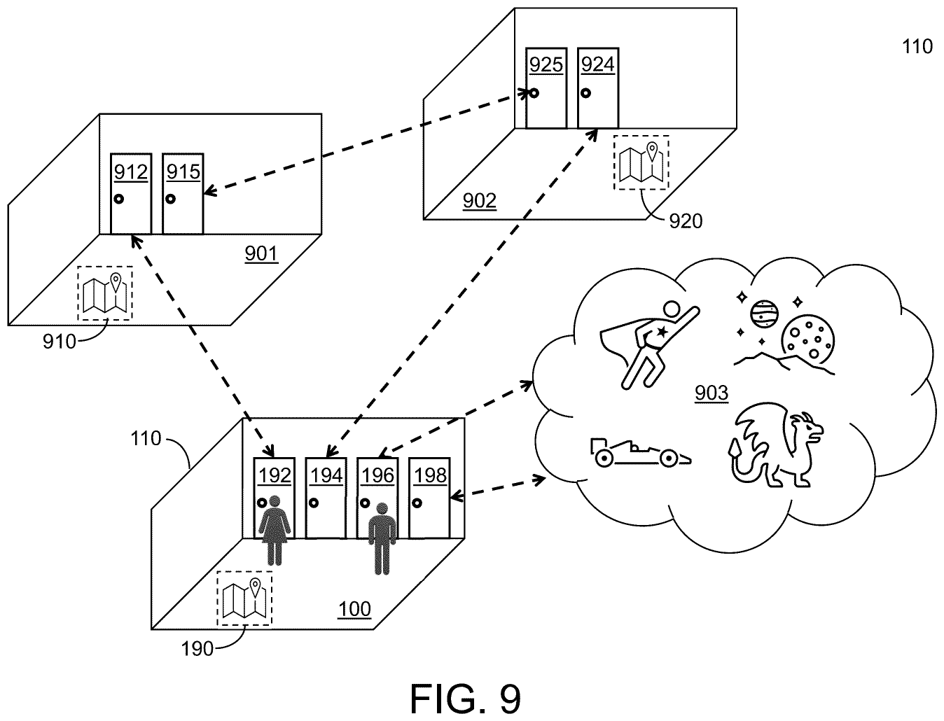

FIG. 9 illustrates an exemplary embodiment of a digital place 100 as a hub for traversing through different digital places and/or digital worlds. Digital place 100 may connect to other digital places and/or digital worlds via, e.g., portals embodied as doors in digital space 110. System 200 in FIG. 2 can embody equipment and services for generating, maintaining, and operating digital places, and a digital-place server(s) (circuitry 220) may host digital places 100, 901, and 902 shown in FIG. 9. Digital places 100, 901, and 902 may collectively connect to each other via doors 192, 194, 912, 915, 924, 925. Each or any of the door connections shown in FIG. 9 may be modifiable. For example, a door may be re-assigned according to user or system preference, such that it is a universal door that can connect to any of, e.g., thousands of different destinations. One door may be configured to access a “moon” space, another door may go to Mars, yet another door may go to a bathroom, still yet another door may go to a bathroom on Mars. For connecting to different digital places and/or digital worlds, digital place 100 may have cross-platform and/or cross-provider interoperability. For example, the digital place 100 may be based on a native application platform by a native application provider and the different digital places and/or digital worlds may be based on other application platforms by other application providers, where the other application platforms are different from the native application platform of digital place 100. The cross-platform and/or cross-provider interoperability may include sharing some foundations, such as sharing the same 3D experience platform (e.g., the same 3D experience engine, the same 3D video game engine, the same 3D file type, etc.), such that digital assets in digital place 100 and in the different digital places and/or digital worlds may have mutual interoperability for maintaining some or full functionalities. For example, with such shared foundations, an avatar in digital place 100 may be playable in both digital place 100 and in one or more different digital places and/or digital worlds with some shared functionalities (e.g., spatial movement, visual appearance, facial movement, body movement, etc.).

According to an embodiment, multiple digital places (accessible by the doors 192-196) may be owned by a single owner or individually by different owners. The door connections may be arranged by one or more owners. For example, connected digital places 100, 901, and 902 may in aggregate form a 3-room virtual housing enclosure structure (e.g., apartment or condo or house or office). Those of skill in the art will acknowledge that the number of connected digital places is not limited, i.e., zero to infinite digital places may be accessible via the doors of any of the digital places. One or more of the digital places 100, 901, 902 may or may not be anchored to a respective real-world geospatial location, as indicated by map-and-pin icons 190, 910, and 920. Digital places 100, 901, and 902 are not limited to single-room embodiments, but each may be embodied by larger and/or more complex structures, such as a digital-place house or a digital-place city block.

In a case that multiple digital places 100, 901, and 902 are owned or controlled by different users, various permission arrangements can be made for distributing different levels of access and modification privileges among different owners and users of digital places 100, 901, and 902. A single digital place may also be owned by a community of multiple users, where the community may set different privileges among its community members. In an example of a trusted friend group of 3 digital-place users, each of the 3 owners of digital places 190, 910, and 920 may have an access key token for each of all digital places 190, 910, and 920, or each digital place 190, 910, and 920 may have a permission structure that permits entry to all 3 friends. The various permission arrangements for digital places 100, 901, and 902 may be stored in storage 226 of a digital-place server (circuitry 220) and accessed and/or modified by users via, e.g., a web user interface 210 or a mobile user interface 212.

The digital-place doors 192-198 may connect to external digital places and/or digital worlds. For example, in digital place 100, each of digital-place doors 196 and 198 may connect to a respective video game world among a vast game gallery 903, including examples of superhero games, sci-fi games, racing games, and fantasy games. When two gamer friends are in a sci-fi game world, one of them may be the owner of digital place 100 who can invite the other friend to come over to her digital-place “house” 100 to show some of her NFT artwork or video game equipment. The two gamer friends can enter digital space 110 via digital-place door 198. After spending some time in digital space 110, the two gamer friends can exit via digital-place door 196 to jump into another game world together.

The owner of digital place 100 may store her NFT video game assets (e.g., weapon(s), armor(s), tool(s), avatar(s)) in NFT asset containers 330, 332, 334, 336. In the digital space 110, she may strategize her selection of video game gear to take with her before entering her target game world via digital-place door 196 or 198. When there is no full standard for interoperability between different digital worlds, such as different video games, the issue of cross-platform interoperability may be a technical problem that can hinder or block the coherent movement of digital assets from one digital world to another. However, where two digital worlds share some foundations, such as a sharing the same 3D experience platform (e.g., the same 3D experience engine, the same 3D video game engine, the same 3D file type, etc.), the digital assets of those two digital worlds may have some mutual interoperability for maintaining some basic functionalities. In some situations, the owner of digital place 100 may obtain NFT digital assets that a video game developer team plans to make playable in a future video game to be developed by the developer team, and digital place 100 can be a useful storage location to hold those NFT digital assets while the future game is under development.

According to an embodiment, one or more of the doors 192-198 may include a door configurator service or that controls the connection to other digital places or to other virtual worlds, platforms, game services, etc. For example, a user may subscribe to a digital-place door configurator service that selectively identifies and/or connects to the respective door(s) digital spaces or worlds of interest to the user. In some embodiments, third party platforms may supply a digital-place door that connects to a virtual world, platform, game world, etc. that the third party owns or controls. In other embodiments the virtual destination for one or more of the doors 192-198 may be changeable or changed based on a social media-based consensus regarding a popular destination accessible via the door.

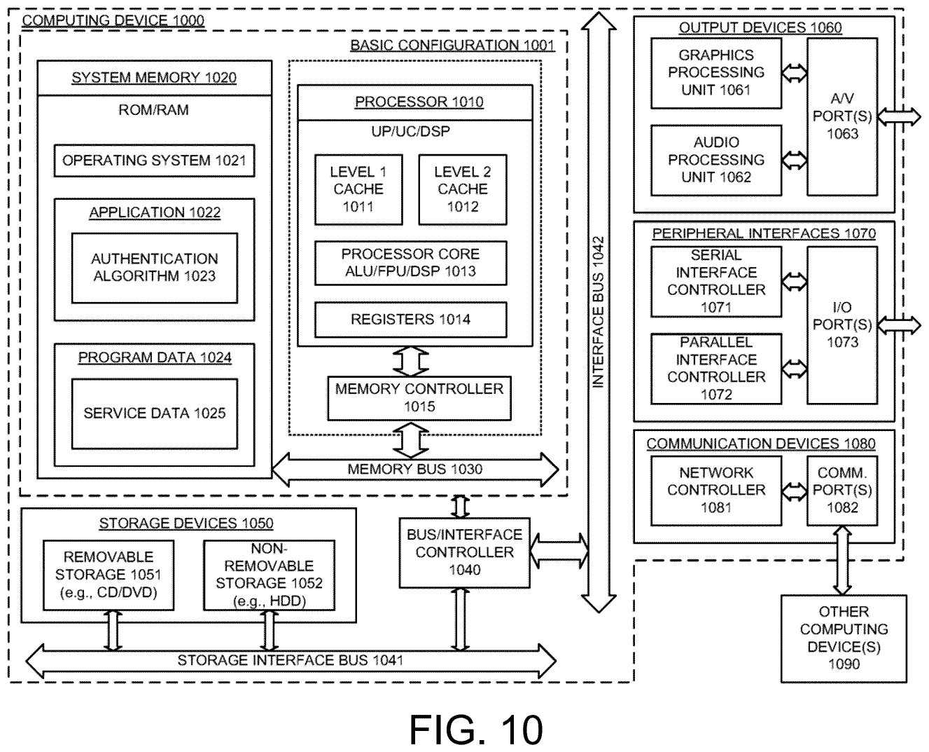

FIG. 10 is a circuit diagram of one aspect of a computing device 1000 that may work in conjunction with the elements of the present disclosure. In a very basic configuration of computing device 1000, the computing device 1000 typically includes one or more processors 1010 and a system memory 1020. A memory bus 1030 can be used for communications between the processor 1010 and the system memory 1020.

Depending on the desired configuration, the one or more processor 1010 of computing device 1000 can be of any type including but not limited to a microprocessor, a microcontroller, a digital signal processor, or any combination thereof. Processor 1010 can include one or more levels of caching, such as a level one cache 1011 and a level two cache 1012, a processor core 1013, and registers 1014. The processor core 1013 can include an arithmetic logic unit (ALU), a floating point unit (FPU), a digital signal processing core (DSP Core), or any combination thereof. A memory controller 1015 can also be used with the processor 1010, or in some implementations the memory controller 1015 can be an internal part of the processor 1010.

Depending on the desired configuration, the system memory 1020 can be of any type including but not limited to volatile memory (such as RAM), non-volatile memory (such as ROM, flash memory, etc.) or any combination thereof. System memory 1020 typically includes an operating system 1021, one or more applications 1022, and program data 1024. Application 1022 includes an authentication algorithm 1023. Program Data 1024 includes service data 1025.

Computing device 1000 can have additional features or functionality, and additional interfaces to facilitate communications between the basic configuration 1001 and any required devices and interfaces. For example, a bus/interface controller 1040 can be used to facilitate communications between the basic configuration 1001 and one or more data storage devices 1050 via a storage interface bus 1041. The data storage devices 1050 can be removable storage devices 1051, non-removable storage devices 1052, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 1020, removable storage 1051 and non-removable storage 1052 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1000. Any such computer storage media can be part of the computing device 1000.

Computing device 1000 can also include an interface bus 1042 for facilitating communication from various interface devices (e.g., output interfaces, peripheral interfaces, communication interfaces, etc.) to the basic configuration 1001 via the bus/interface controller 1040. Example output devices 1060 include a graphics processing unit 1061 and an audio processing unit 1062, which can be configured to communicate to various external devices such as a display or speakers via one or more A/V ports 1063. Example peripheral interfaces 1070 include a serial interface controller 1071 or a parallel interface controller 1072, which can be configured to communicate with external devices such as input devices (e.g., keyboard, mouse, pen, voice input device, touch input device, etc.) or other peripheral devices (e.g., printer, scanner, etc.) via one or more I/O ports 1073. An example communication device 1080 includes a network controller 1081, which can be arranged to facilitate communications with one or more other computing devices 1090 over a network communication via one or more communication ports 1082. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

It should be noted that the circuitry 220, web user interface 210, mobile user interface 212, and/or electronic devices of distributed ledger network 240 in FIG. 2 may work in conjunction with the teachings disclosed by computing device 1000. Web user interface 210 may be part of a computing device that is comprised directly of elements shown in computing device 1000. Mobile user interface 212 may be part of a computing device that is comprised directly of elements shown in computing device 1000. An electronic device of distributed ledger network 240 may be a computing device that is comprised directly of elements shown in computing device 1000. Circuitry 220 may be a computing device that is comprised directly of elements shown in computing device 1000 and in combination with the teachings of FIG. 2; for example, one or more GPUs 228 may be included, not among output devices 1060, but with processor 1010 and system memory 1020 on memory bus 1030.

Computing device 1000 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1000 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the invention, and all such modifications as would be obvious to one skilled in the art are intended to be included within the scope of the following claims.

We claim:

1. A system comprising:
circuitry configured for:
hosting a first digital place to be displayed via a display of a user interface, wherein:
the first digital place is authenticated by a first non-fungible token (NFT), and
the first NFT is stored on a distributed ledger network;
integrating one or more external services into the first digital place, the one or more external services providing at least one of visual content and audio content to be presented in correspondence with the first digital place via the user interface, wherein:
the first digital place is provided by a first application provider,
the one or more external services are provided by one or more first external application providers, and
the first application provider is different from the one or more first external application providers; and
non-transitory computer-readable storage for storing one or more parameter values defining one or more aspects of the first digital place, wherein:
one or more visually perceptible traits of the first digital place are based on the stored one or more parameter values, and
the one or visually perceptible traits of the first digital place are to be displayed via the display of the user interface.

2. The system of claim 1, wherein:
the first digital place comprises a first digital space,
the first digital place is to be displayed via the display of the user interface by the first digital space being displayed via the display of the user interface,
the one or more external services are integrated into the first digital space,
the stored one or more parameter values defining one or more aspects of the first digital place define one or more aspects of the first digital space,
the one or more visually perceptible traits of the first digital place are one or more visually perceptible traits of the first digital space, and
the one or visually perceptible traits of the first digital place are to be displayed via the display of the user interface by the one or more visually perceptible traits of the first digital space being displayed via the display of the user interface.

3. The system of claim 1, wherein:
the circuitry is further configured for:
hosting a second digital place to be displayed via the display of the user interface, wherein:
the second digital place is authenticated by a second NFT, and
the second NFT is stored on the distributed ledger network; and
connecting the first digital place to the second digital place, wherein traversing between the first digital place and the connected second digital place occurs via a portal visually presented in the first digital place, the visually presented portal to be displayed via the display of the user interface.

4. The system of claim 1, wherein:
the circuitry is further configured for:
connecting the first digital place to a first digital world, wherein:
the first digital place is provided by the first application provider,
the first digital world is provided by a second external application provider,
the first application provider is different from the second external application provider, and
traversing from the first digital place to the first digital world occurs via a portal visually presented in the first digital place, the visually presented portal to be displayed via the display of the user interface.

5. The system of claim 1, wherein:
the circuitry is further configured for:
hosting a map program that maintains a map at least partially corresponding to geographical space;
receiving a user input from a first user interface to anchor the first digital place to a geospatial location on the map, the geospatial location associated with the first user interface; and
updating the map, based on the user input from the first user interface, to set the geospatial location associated with the first user interface as an anchor location of the anchored first digital place; and
the non-transitory computer-readable storage for storing the updated map.

6. The system of claim 4, wherein:
the circuitry is further configured for:
receiving a user input from the second user interface to visit the anchored first digital place; and
presenting, based on the user input from the second user interface, at least some aspect of the first digital place, the at least some aspect of the first digital place to be displayed via a display of the second user interface.

7. The system of claim 1, wherein:
the circuitry is configured for:
receiving input data from one or more user interfaces, wherein:
the input data comprises a plurality of images of a first physical place at a first geospatial location, and
the plurality of images captured by one or more cameras of the one or more user interfaces when located at the first geospatial location;
performing image processing or analysis on the input data to:
stitch together the plurality of images into one or more coherent images of the first physical place or
generate a point cloud based on the plurality of images;
determining three-dimensional (3D) data for the first physical place based on the one or more coherent images of the first physical space or based on generated point cloud; and
performing 3D reconstruction or 3D modeling to shape the first digital place based on the 3D data; and
the non-transitory computer-readable storage for storing the plurality of images and one or more parameter values for the shaped first digital place, wherein:
one or more visually perceptible traits of the shaped first digital place are based on the stored one or more parameter values for the shaped first digital place, and
the one or visually perceptible traits of the shaped first digital place are to be displayed via the display of the user interface.

8. The system of claim 7, wherein:
the circuitry is configured for:
hosting a map program that maintains a map, wherein the shaped first digital place is anchored to an anchor location on the map;
receiving a user input from the user interface to visit the anchored shaped first digital place; and
presenting, based on the user input from the user interface, at least some aspect of the shaped first digital place, the at least some aspect of the shaped first digital place to be displayed via the display of the user interface.

9. The system of claim 1, wherein:
the circuitry is configured for:
hosting a map program that maintains a map;
receiving input data from a first user interface, wherein:
the input data comprises a first elevation entry for the first digital place at a first geospatial location, and
the first elevation entry indicates an elevation of the first user interface when located at the first geospatial location;
updating the map, based on the input data from the first user interface, to set a first elevation of the first digital place at the first geospatial location; and
the non-transitory computer-readable storage for storing the map updated with the first elevation.

10. The system of claim 9, wherein:
the circuitry is configured for:
receiving input data from a second user interface, wherein:
the input data comprises a second elevation entry for the first digital place at the first geospatial location, and
the second elevation entry indicates an elevation of the second user interface when located at the first geospatial location; and
updating the map, based on the input data from the second user interface and based on the first elevation of the first digital place at the first geospatial location, to set an updated elevation of the first digital place at the first geospatial location; and
the non-transitory computer-readable storage for storing the map updated with the updated elevation.

11. A non-transitory computer-readable medium storing instructions, such that when the instructions are executed by one or more processors, the one or more processors are configured to perform a method comprising:
hosting a first digital place to be displayed via a display of a user interface, wherein:
the first digital place is authenticated by a first non-fungible token (NFT), and
the first NFT is stored on a distributed ledger network;
integrating one or more external services into the first digital place, the one or more external services providing at least one of visual content and audio content to be presented in correspondence with the first digital place via the user interface, wherein:
the first digital place is provided by a first application provider,
the one or more external services are provided by one or more first external application providers, and
the first application provider is different from the one or more first external application providers; and
wherein one or more parameter values defining one or more aspects of the first digital place are stored by a non-transitory computer-readable storage, wherein:
one or more visually perceptible traits of the first digital place are based on the stored one or more parameter values, and
the one or visually perceptible traits of the first digital place are to be displayed via the display of the user interface.

12. The non-transitory computer-readable medium of claim 11, wherein:
the first digital place comprises a first digital space,
the first digital place is to be displayed via the display of the user interface by the first digital space being displayed via the display of the user interface,
the one or more external services are integrated into the first digital space,
the stored one or more parameter values defining one or more aspects of the first digital place define one or more aspects of the first digital space,
the one or more visually perceptible traits of the first digital place are one or more visually perceptible traits of the first digital space, and
the one or visually perceptible traits of the first digital place are to be displayed via the display of the user interface by the one or more visually perceptible traits of the first digital space being displayed via the display of the user interface.

13. The non-transitory computer-readable medium of claim 11, wherein the method further comprises:
hosting a second digital place to be displayed via the display of the user interface, wherein:
the second digital place is authenticated by a second NFT, and
the second NFT is stored on the distributed ledger network; and
connecting the first digital place to the second digital place, wherein traversing between the first digital place and the connected second digital place occurs via a portal visually presented in the first digital place, the visually presented portal to be displayed via the display of the user interface.

14. The non-transitory computer-readable medium of claim 11, wherein the method further comprises:
connecting the first digital place to a first digital world, wherein:
the first digital place is provided by the first application provider,
the first digital world is provided by a second external application provider,
the first application provider is different from the second external application provider, and
traversing from the first digital place to the first digital world occurs via a portal visually presented in the first digital place, the visually presented portal to be displayed via the display of the user interface.

15. The non-transitory computer-readable medium of claim 11, wherein the method further comprises:
hosting a map program that maintains a map at least partially corresponding to geographical space;
receiving a user input from a first user interface to anchor the first digital place to a geospatial location on the map, the geospatial location associated with the first user interface; and
updating the map, based on the user input from the first user interface, to set the geospatial location associated with the first user interface as an anchor location of the anchored first digital place,
wherein the updated map is stored on the non-transitory computer-readable storage.

16. The non-transitory computer-readable medium of claim 15, wherein the method further comprises:
receiving a user input from the second user interface to visit the anchored first digital place; and
presenting, based on the user input from the second user interface, at least some aspect of the first digital place, the at least some aspect of the first digital place to be displayed via a display of the second user interface.

17. The non-transitory computer-readable medium of claim 11, wherein the method further comprises:
receiving input data from one or more user interfaces, wherein:
the input data comprises a plurality of images of a first physical place at a first geospatial location, and
the plurality of images captured by one or more cameras of the one or more user interfaces when located at the first geospatial location;
performing image processing or analysis on the input data to:
stitch together the plurality of images into one or more coherent images of the first physical place or
generate a point cloud based on the plurality of images;
determining three-dimensional (3D) data for the first physical place based on the one or more coherent images of the first physical space or based on generated point cloud; and
performing 3D reconstruction or 3D modeling to shape the first digital place based on the 3D data,
wherein the plurality of images and one or more parameter values for the shaped first digital place are stored by the non-transitory computer-readable storage, wherein:
one or more visually perceptible traits of the shaped first digital place are based on the stored one or more parameter values for the shaped first digital place, and
the one or visually perceptible traits of the shaped first digital place are to be displayed via the display of the user interface.

18. The non-transitory computer-readable medium of claim 17, wherein the method further comprises:
hosting a map program that maintains a map, wherein the shaped first digital place is anchored to an anchor location on the map;
receiving a user input from the user interface to visit the anchored shaped first digital place; and
presenting, based on the user input from the user interface, at least some aspect of the shaped first digital place, the at least some aspect of the shaped first digital place to be displayed via the display of the user interface.

19. The non-transitory computer-readable medium of claim 11, wherein the method further comprises:
hosting a map program that maintains a map;
receiving input data from a first user interface, wherein:
the input data comprises a first elevation entry for the first digital place at a first geospatial location, and
the first elevation entry indicates an elevation of the first user interface when located at the first geospatial location;
updating the map, based on the input data from the first user interface, to set a first elevation of the first digital place at the first geospatial location,
wherein the map updated with the first elevation is stored by the non-transitory computer-readable storage.

20. The non-transitory computer-readable medium of claim 19, wherein the method further comprises:
receiving input data from a second user interface, wherein:
the input data comprises a second elevation entry for the first digital place at the first geospatial location, and
the second elevation entry indicates an elevation of the second user interface when located at the first geospatial location; and
updating the map, based on the input data from the second user interface and based on the first elevation of the first digital place at the first geospatial location, to set an updated elevation of the first digital place at the first geospatial location,
wherein the map updated with the updated elevation is stored by the non-transitory computer-readable storage.
